(19) United States
(12) Patent Application Publication
(10) Pub. No.: US 2026/0339227 A1
(43) Pub. Date: Oct. 29, 2026

(54) IRON ION ELUTING BODY AND METHOD OF PRODUCING SAME

(71) Applicant: SHARP KABUSHIKI KAISHA, Sakai City (JP)

(72) Inventor: TAKASHI HARA, Sakai City (JP)

(21) Appl. No.: 19/637,279

(22) Filed: Apr. 2, 2026

(30) Foreign Application Priority Data
Apr. 24, 2025 (JP) 2025-072288

(51) Int. Cl. G03G 9/08; G03G 9/087; G03G 9/09; G03G 9/107

(52) U.S. Cl. CPC G03G 9/0808; G03G 9/08755; G03G 9/0904; G03G 9/0918; G03G 9/108

(57) ABSTRACT

A molded body obtained by press-molding an iron-containing composition is adopted as an iron ion eluting body that elutes iron ions in an aqueous medium. The iron-containing composition contains a magnetic particle containing iron, a resin particle containing a colorant, and an elution aid that reacts with iron or a compound containing iron to form an iron complex.

### TECHNICAL FIELD

The disclosure relates to an iron ion eluting body and a method of producing the same.

### BACKGROUND ART

Two-component developers containing a carrier and a toner are widely used as developers in image forming devices that use an electrophotographic method, such as in copiers, multi-function printers, printers, and facsimile machines. In general, the carrier has a configuration in which magnetic particles containing iron are used as a core material. The toner has a configuration in which an external additive is attached to a surface of a resin particle (toner particle) in which an internal additive such as a colorant is present in a state of being dispersed in a resin. Such a toner is fixed on a recording medium such as paper, thereby forming an image on the recording medium.

Meanwhile, an iron ion eluting body that elutes iron ions in water can purify water because eluted divalent iron ions bind to phosphorus and nitric acid that cause eutrophication. For example, an iron ion eluting body obtained by mixing iron powder and coke powder (carbon) and sintering the mixture is known.

### SUMMARY

### Technical Problem

The carrier contained in the two-component developer is composed of a carrier core material containing iron and a resin coating layer coating a surface of the carrier core material, and has a function of charging and transporting the toner in a development tank of the image forming device. While the carrier is repeatedly used in the development tank, the carrier degrades due to contamination from toner components, detachment and wear of the resin coating layer, and the like, and thus must be replaced with a new carrier.

The present inventor has studied reuse of the used two-component developer as an iron ion eluting body, but there is a problem that an amount of iron ions eluted is small if the used two-component developer is reused as it is, and that it takes time until the iron ions are sufficiently eluted.

In addition, an iron ion eluting body utilizing a battery reaction between iron and carbon, such as an iron ion eluting body obtained by mixing iron powder and coke powder and sintering the mixture, can be expected to continuously elute iron ions, but has a problem in fast-acting property.

The iron ion eluting body of the disclosure has been found in view of such circumstances, and a main object thereof is to provide an iron ion eluting body in which iron ions are rapidly eluted in an aqueous medium and the elution of iron ions is continued even after the aqueous medium is replaced with a new one, and a method of producing the same.

### Solution to Problem

An iron ion eluting body of the disclosure made to solve the above problem is an iron ion eluting body that elutes iron ions in an aqueous medium, characterized by being a molded body obtained by press-molding an iron-containing composition, the iron-containing composition containing:
a magnetic particle containing iron;
a resin particle containing a colorant; and
an elution aid that reacts with iron or a compound containing iron to form an iron complex.

In the iron ion eluting body, the elution aid is preferably at least one of a chelating agent and a reducing organic substance.

In the iron ion eluting body, the elution aid is preferably water-soluble.

In the iron ion eluting body, the iron-containing composition preferably further contains a carbon material.

In the iron ion eluting body, the carbon material is preferably carbon black.

In the iron ion eluting body, magnetite is preferably attached to a surface of the resin particle.

In the iron ion eluting body, the colorant is preferably a conductive particle.

In the iron ion eluting body, a resin constituting the resin particle is preferably a polyester resin.

A method of producing an iron ion eluting body of the disclosure made to solve the above problem is a method of producing an iron ion eluting body that elutes iron ions in an aqueous medium, characterized by including:
an addition step of adding an elution aid that reacts with iron or a compound containing iron to form an iron complex to a two-component developer composed of a toner and a carrier to obtain an iron-containing composition; and
a molding step of press-molding the iron-containing composition to obtain a molded body.

In addition, a method of producing an iron ion eluting body of the disclosure made to solve the above problem is a method of producing an iron ion eluting body that elutes iron ions in an aqueous medium, characterized by including:
a heating step of heating a two-component developer composed of a toner containing a polyester resin and a carrier; and
a molding step of press-molding the two-component developer after the heating step to obtain a molded body.

### Advantageous Effects of Disclosure

The iron ion eluting body of the disclosure provides excellent effects such as rapid elution of iron ions in the aqueous medium and continued elution of iron ions even after the aqueous medium is replaced with a new one.

### BRIEF DESCRIPTION OF THE DRAWINGS

FIG. 1 is a schematic diagram illustrating constituent components of an iron ion eluting body according to an embodiment of the disclosure.

FIG. 2 is a schematic diagram illustrating an overall configuration of the iron ion eluting body according to the embodiment of the disclosure.

FIG. 3 is a schematic diagram illustrating a state in the vicinity of a carrier in the iron ion eluting body according to the embodiment of the disclosure.

FIG. 4 is a schematic diagram illustrating that, when the iron ion eluting body of FIG. 3 is introduced into an aqueous medium, an elution aid and iron ions are eluted from the iron ion eluting body.

FIG. 5 is a schematic diagram illustrating that the elution aid and the iron ions continue to be eluted from the iron ion eluting body even after a lapse of time from the state illustrated in FIG. 4.

### DESCRIPTION OF EMBODIMENTS

The iron ion eluting body of the disclosure will be described below. In the disclosure, “internally added” means that an additive is added in such a manner as to be contained inside an additive-receiving material, and “externally added” means that an additive is added in such a manner as to be adherent to an outer surface (surface) of an additive-receiving material. In addition, the median diameter and the average particle size in the disclosure are based on volume unless otherwise specified.

### 1. Overall Configuration of Iron Ion Eluting Body

The iron ion eluting body according to the present embodiment is a molded body obtained by press-molding an iron-containing composition containing the following (A) to (C).
(A) A magnetic particle containing iron.
(B) A resin particle containing a colorant.
(C) An elution aid that reacts with iron or a compound containing iron to form an iron complex.

Specifically, in the present embodiment, the iron-containing composition is obtained by adding an additive such as an elution aid to a two-component developer, the magnetic particle (A) is derived from a carrier, and the resin particle (B) is derived from a toner. The two-component developer may be unused or used for development, and the environmental load can be reduced by reusing the used two-component developer to produce the iron ion eluting body.

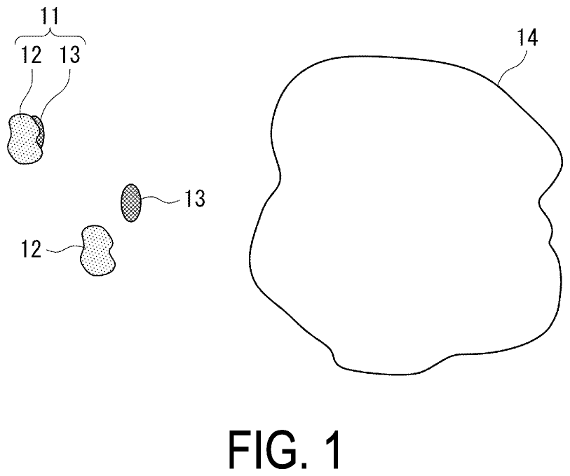

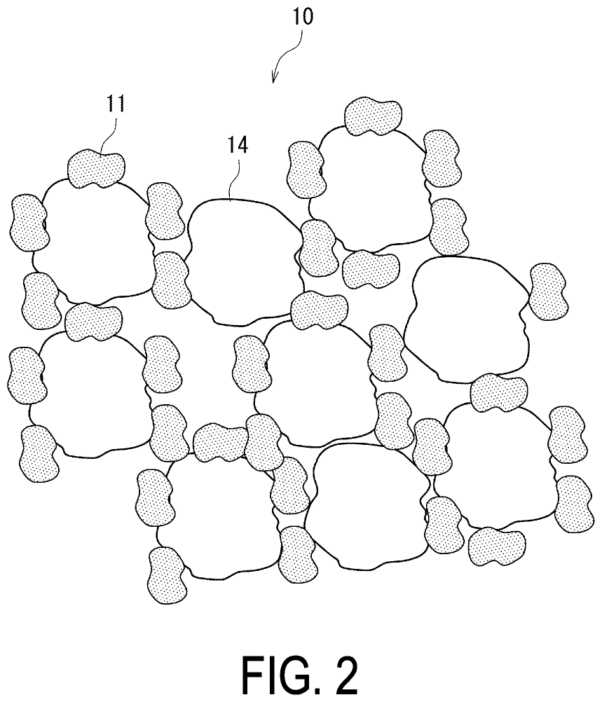

FIG. 1 is a schematic diagram illustrating constituent components of an iron ion eluting body according to an embodiment of the disclosure, and FIG. 2 is a schematic diagram illustrating an overall configuration of the iron ion eluting body according to the embodiment of the disclosure. An iron ion eluting body 10 contains, as constituent components, a toner 12 as a resin particle containing a colorant, an elution aid 13, and a carrier 14 as a magnetic particle containing iron. Since the iron ion eluting body 10 is a mixture of these components, the iron ion eluting body 10 schematically has a configuration in which a plurality of toner composites 11, which are composites of the toner 12 and the elution aid 13, are present around the carrier 14.

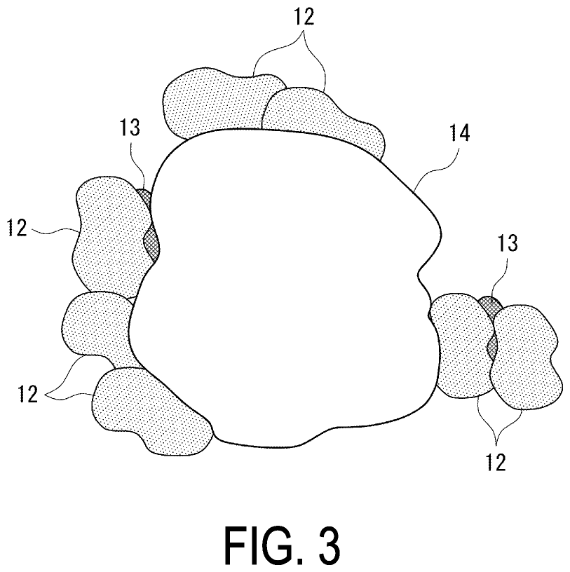

Here, a presumed mechanism in which the iron ion eluting body according to the present embodiment rapidly elutes iron ions in an aqueous medium and the elution of iron ions is continued even after the aqueous medium is replaced with a new one will be described with reference to FIGS. 3 to 5.

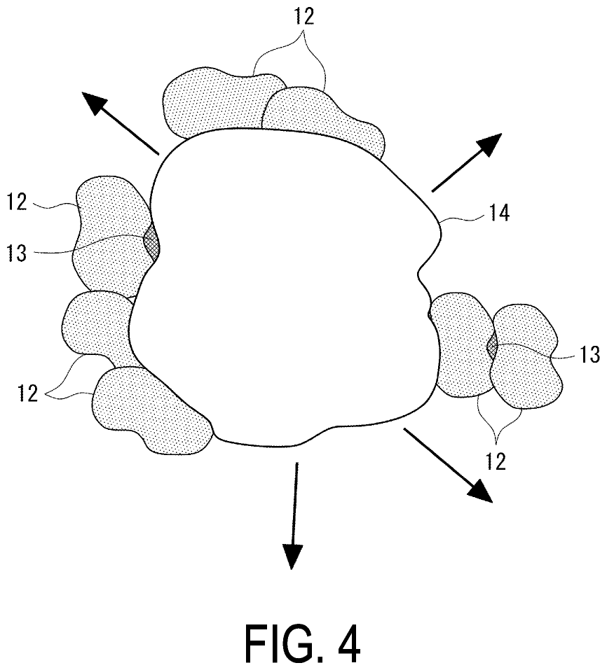

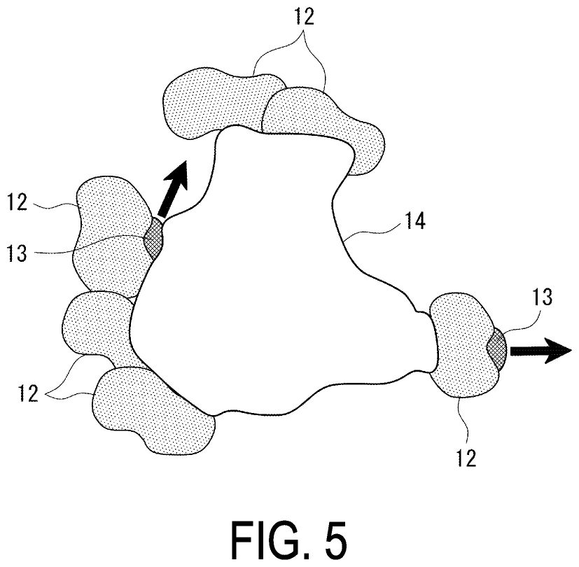

FIG. 3 is a schematic diagram illustrating a state in the vicinity of a carrier in the iron ion eluting body according to the embodiment of the disclosure, FIG. 4 is a schematic diagram illustrating that, when the iron ion eluting body of FIG. 3 is introduced into an aqueous medium, an elution aid and iron ions are eluted from the iron ion eluting body, and FIG. 5 is a schematic diagram illustrating that the elution aid and the iron ions continue to be eluted from the iron ion eluting body even after a lapse of time from the state illustrated in FIG. 4.

As illustrated in FIG. 3, the toner 12 and the elution aid 13 are present around the carrier 14 in the iron ion eluting body 10. When the iron ion eluting body 10 is introduced into an aqueous medium (typically, water to be purified), the elution aid 13 present in a portion in contact with the aqueous medium is rapidly eluted (diffused even when not dissolved) as illustrated in FIG. 4, and elution of iron ions from the carrier 14 is promoted. That is, in the iron ion eluting body according to the present embodiment, iron ions are rapidly eluted in the aqueous medium.

As illustrated in FIG. 4, the elution aid 13 present in a portion not in contact with the aqueous medium is not eluted or diffused in the aqueous medium at this stage, and does not react with the carrier 14 so much. Then, as time passes from the state illustrated in FIG. 4, a shape of the carrier 14 changes, and the toner 12 is slowly decomposed. Then, as illustrated in FIG. 5, the elution aid 13 that was not in contact with the aqueous medium at an initial stage of the introduction is exposed and gradually eluted or diffused in the aqueous medium.

The elution aid 13 confined between the toner 12 and the carrier 14 is eluted or diffused by being brought into contact with the aqueous medium with a delay, so that an effect of aiding elution of the iron ions from the carrier 14 is sequentially exhibited. Therefore, even when time has passed after the iron ion is introduced into the aqueous medium or the aqueous medium present around the iron ion eluting body is replaced due to a water flow or the like, the elution of the iron ions is continued.

The iron ion eluting body according to the present embodiment is a molded body obtained by press-molding the iron-containing composition as described above. The elution aid present inside the molded body is less likely to come into contact with the aqueous medium in the initial stage of the introduction, and comes into contact with the aqueous medium with the lapse of time, and therefore, the elution of the iron ions is continued longer than in a case where the iron ion eluting body is in the form of a powder. A shape of the molded body is not particularly limited, and a pellet having a cylindrical shape with a diameter of 10 mm or more and 50 mm or less can be exemplified.

From the iron ion eluting body according to the present embodiment, an iron component is eluted as the iron ions (iron complex) into the aqueous medium, and therefore, an effect that the iron component is easily incorporated into plants and phytoplankton is also exhibited.

### 2. Iron-Containing Composition (Two-Component Developer and Additive)

The iron ion eluting body according to the present embodiment is a molded body obtained by press-molding an iron-containing composition obtained by adding an additive containing an elution aid to a two-component developer. The two-component developer can be produced by mixing a toner and a carrier using a known mixer. The additive containing an elution aid may be added to a used two-component developer (a two-component developer as a finished product) or may be added in a process of producing the two-component developer.

That is, the iron ion eluting body according to the present embodiment may be produced by a production method including an addition step of adding an elution aid to a two-component developer composed of a toner and a carrier to obtain an iron-containing composition, and a molding step of press-molding the iron-containing composition obtained in the addition step to obtain a molded body. In this production method, the environmental load can be reduced by using a used two-component developer as a raw material.

### Additive Containing Elution Aid

The iron ion eluting body according to the present embodiment contains an elution aid. The iron ion eluting body may be produced by adding a compound itself as the elution aid to the two-component developer, or the iron ion eluting body may be produced by adding an “additive containing an elution aid” (for example, a plant body or a processed product thereof described later) to the two-component developer.

In addition, in a case where a component functioning as the elution aid is contained in the two-component developer itself used as a raw material, the iron ion eluting body may be produced without separately adding the elution aid. Specifically, in a case where a binder resin of the toner is a polyester resin, a dicarboxylic acid such as succinic acid produced by hydrolysis of the polyester resin acts as a chelating agent. Therefore, in a case where the binder resin is a polyester resin, the dicarboxylic acid contained in a hydrolyzed toner (for example, a toner in a used two-component developer) functions as the elution aid. By using a used two-component developer containing the toner of which hydrolysis has proceeded as a raw material, the iron ion eluting body according to the present embodiment may be produced without separately adding the elution aid. Specifically, the hydrolysis of the polyester resin proceeds with the lapse of time, but the hydrolysis of the polyester resin may be promoted by heating the two-component developer by a method of placing the two-component developer under heated water vapor. That is, the iron ion eluting body according to the present embodiment can also be produced by a production method including a heating step of heating a two-component developer containing a polyester resin and a molding step of press-molding the two-component developer after the heating step to obtain a molded body.

The elution aid according to the present embodiment is a substance that reacts with iron or a compound containing iron to form an iron complex. Such a substance includes a chelating agent and a reducing organic substance. In the case of the chelating agent, an effect of stabilizing an iron eluted substance by chelation with iron and an effect of promoting elution of iron ions from ferrite (iron oxide) are obtained. In the case of the reducing organic substance, an effect of dissolving metal iron and reducing ferrite (iron oxide) to elute iron ions, and an effect of reducing trivalent iron ions to increase divalent iron ions are obtained.

That is, the elution aid according to the present embodiment is preferably at least one of the chelating agent and the reducing organic substance.

As the chelating agent, any compound can be used as long as it is a compound that exhibits a chelate complex by coordination to a metal ion, and examples thereof include citric acid, succinic acid, glutamic acid, EDTA (ethylenediaminetetraacetic acid), DTPA (diethylenetriaminepentaacetic acid), fulvic acid, and organic humic acid. The chelating agent can be selected and used depending on the purpose. One of these may be used individually, or two or more thereof may be used in combination.

As the reducing organic substance, any organic substance can be used as long as it is an organic substance having an action of reducing a trivalent iron ion (ferric iron) to a divalent iron ion (ferrous iron), and examples thereof include ascorbic acid and polyphenols. The reducing organic substance can be selected and used depending on the purpose. Polyphenols are compounds having a plurality of phenolic hydroxy groups in the molecule, and include flavonoids, tea catechins, phlorotannins, and the like, and examples thereof include catechin, tannic acid, chlorogenic acid, caffeic acid, neochlorogenic acid, cyanidin, proanthocyanidin, thearubigin, rutin, xanthophyll, carnosic acid, eriocitrin, magnolol, honokiol, ellagic acid, lignan, curcumin, catechol, procyanidin, theaflavin, rosmarinic acid, quercetin, resveratrol, and gallic acid. One of these may be used individually, or two or more may be used in combination.

In the iron ion eluting body according to the present embodiment, a content of the elution aid is, for example, 0.1 parts by mass or more and 30 parts by mass or less, preferably 0.5 parts by mass or more and 20 parts by mass or less, and more preferably 2 parts by mass or more and 15 parts by mass or less with respect to 100 parts by mass of the toner particles. When the content of the elution aid is within the above range, the function as the elution aid is sufficiently exhibited. Accordingly, the effect of rapid elution of iron ions in the aqueous medium and the effect of continued elution of iron ions even after the aqueous medium is replaced with a new one are exhibited.

The elution aid according to the present embodiment is preferably water-soluble. In the disclosure, the term “water-soluble” means that 1 g or more of a target substance is dissolved in 100 g of water at 20 °C. In addition, although solubility of an ionic compound that forms an ion pair increases, the water-solubility is determined based on the solubility of the compound alone. Due to the elution aid being water-soluble, the elution aid is rapidly eluted when the iron ion eluting body according to the present embodiment is introduced into the aqueous medium, and therefore, an iron ion eluting body having a more excellent fast-acting property can be obtained. The elution aid according to the present embodiment is more preferably dissolved in an amount of 3 g or more, still more preferably dissolved in an amount of 20 g or more, and particularly preferably dissolved in an amount of 5 g or more, in 100 g of water at 20 °C.

The aspect in which the iron ion eluting body according to the present embodiment contains a chelating agent or a reducing organic substance as the elution aid is not limited to an aspect in which the iron ion eluting body contains these compounds themselves, and may be an aspect in which the iron ion eluting body contains salts of these compounds or a compound having one or more of these compounds in the molecule (for example, a composite in which these compounds are bonded and polymerized in a form of containing these compounds).

As described above, the iron ion eluting body according to the present embodiment may be an iron ion eluting body in which the “additive containing an elution aid” is added to the two-component developer. Examples of such additives can include plant bodies and processed products thereof. Many of plant bodies and processed products thereof contain at least one of the chelating agent and the reducing organic substance, and are suitable as the additive. The “plant body” in the disclosure is a collection of organisms that perform photosynthesis, and is a concept including algae.

Examples of such processed products of plant bodies include dried products, squeezed liquids, and extracts (for example, extracts obtained using water or alcohol as a solvent) of plant bodies. Further, a dried product obtained by drying the squeezed liquid or extract thereof is also included. From the viewpoint of reaction efficiency with iron (or a compound containing iron) as the elution aid, in the case of the dried product, it is preferable to reduce a particle size of the dried product by performing a treatment such as crushing, pulverization, or powdering.

Specific examples of processed products of plant bodies include strained residue and extracted residue (residue) of tea, coffee, shochu, vegetables, fruits, sugar cane, and the like, and tea residue is used as the “additive containing an elution aid” in Example 23 and coffee residue is used as the “additive containing an elution aid” in Example 24, which will be described later. Although the residue of a material used as food is suitable as an additive also from the viewpoint of safety, an additive collected from a material other than food (for example, organic deposits deposited on the bottom of a water area) and subjected to detoxification treatment as necessary can also be used.

### Carbon Material

The iron ion eluting body according to the present embodiment preferably further contains a carbon material in addition to the elution aid described above. That is, it is preferable to produce the iron ion eluting body according to the present embodiment by adding a carbon material to a two-component developer. When the iron ion eluting body contains a carbon material, the carbon material forms a battery with iron, and has an effect of eluting iron ions. The effect is continued even after the aqueous medium around the iron ion eluting body is replaced due to a water flow or the like. In addition, the carbon material also functions as a binder for press-molding the two-component developer to form a molded body.

Examples of the carbon material include carbon black, acetylene black, coke, charcoal, activated carbon, coal powder, graphite, coal tar pitch, and porous carbon materials. One of these may be used individually, or two or more may be used in combination.

Among these materials, carbon black is suitable as the carbon material. By using carbon black, which is a fine particle, as the carbon material, an effect of promoting molecular adsorption and accelerating absorption of a substance that causes an odor or the like present in the aqueous medium is also obtained. Examples of the carbon black include the same carbon blacks as those used as the colorant described below.

A shape and a particle size of the carbon material are not particularly limited, but the carbon material is preferably a powder in order to increase the number of contact points with the carrier core material, and the particle size is preferably smaller than that of the carrier. The smaller the particle size, the larger the specific surface area and the larger the number of contact points with the carrier core material. Therefore, the carbon material has an average secondary particle size of preferably 500 μm or less and an average primary particle size of preferably 50 μm or less.

A content of the carbon material in the iron ion eluting body according to the present embodiment is preferably 0.5 parts by mass or more and 5 parts by mass or less, and more preferably 1 part by mass or more and 4 parts by mass or less with respect to 100 parts by mass of the toner particles.

### 3. Carrier

The iron ion eluting body according to the present embodiment contains a carrier. The carrier is composed of a carrier core material that is a magnetic particle and a resin coating layer coating a surface of the carrier core material. A median diameter of the carrier is, for example, 20 μm or more and 100 μm or less, and preferably 40 μm or more and 70 μm or less.

The carrier core material may be any iron-containing material commonly used in the field of electrophotography. Examples of its constituent substance include magnetic metals such as iron, copper, nickel, and cobalt, and magnetic metal oxides such as ferrite and magnetite.

Examples of particles containing a ferrite component (ferritic particles) include particles of zinc-based ferrite, nickel-based ferrite, copper-based ferrite, nickel-zinc-based ferrite, manganese-magnesium-based ferrite, copper-magnesium-based ferrite, manganese-zinc-based ferrite, and manganese-copper-zinc-based ferrite.

In the present embodiment, the carrier core material preferably contains iron and manganese or magnesium. This makes it possible to elute manganese ions or magnesium ions together with divalent iron ions into the aqueous medium. Since manganese and magnesium are essential elements for plants, aquatic plants and phytoplankton can be activated by eluting manganese ions or magnesium ions into water in water areas such as rivers and water channels. Furthermore, magnesium oxide produced from the eluted magnesium ions improves the pH of sediment and can suppress generation of hydrogen sulfide gas and odors produced from sludge. From this viewpoint, the carrier core material is preferably particles of manganese-magnesium-based ferrite.

For the resin coating layer, a substance commonly used in the field of electrophotography can be used. Examples of the constituent substance include polytetrafluoroethylene, a mono-chlorotrifluoroethylene polymer, polyvinylidene fluoride, silicone resin, polyester resin, a metal compound of di-tert-butylsalicylic acid, a styrene-based resin, an acrylic-based resin, a polyamide, polyvinyl butyral, nigrosine, an aminoacrylate resin, a basic dye, and a lake product of a basic dye.

The resin coating layer can be formed, for example, by applying a solution containing a coating resin to a surface of the carrier core material to form a coating layer, volatilizing and removing an organic solvent from the coating layer by heating, and further heating and curing or simply curing the coating layer during or after drying.

The resin coating layer may contain a carbon material. A content of the carbon material in the resin coating layer is, for example, 0.3 parts by mass or more and 5.0 parts by mass or less, and preferably 0.5 parts by mass or more and 3.0 parts by mass or less, with respect to 100 parts by mass of the coating resin. Examples of the carbon material include those exemplified in the item “Carbon Material” in the “2. Iron-Containing Composition”, and among them, carbon black is suitable.

### 4. Toner

The iron ion eluting body according to the present embodiment contains a toner. The toner contains toner particles that are resin particles and an external additive attached to surfaces of the toner particles.

The toner particles according to the present embodiment include a binder resin and an internal additive such as a colorant, and the internal additive is dispersed in the binder resin. Further, if necessary, an optional component such as a wax dispersant or a pulverization aid may be included as long as the effects according to the disclosure are not impaired. A median diameter of the toner particles can be appropriately selected depending on the purpose and is, for example, 5 μm or more and 8 μm or less.

Hereinafter, each component constituting the toner will be described. A method of producing the toner particles is not particularly limited, and the toner particles can be obtained by a known production method. The toner particles can be produced by a melt-kneading pulverization method.

### Binder Resin

In the present embodiment, as the binder resin, a known binder resin for a black toner or a color toner may be used, and examples thereof include a polyester resin, a styrene-based resin (polystyrene, a styrene-acrylic resin, or the like), an acrylic resin (polymethyl methacrylate or the like), a polyolefin-based resin (polyethylene or the like), polyurethane, and an epoxy resin. One of these resins may be used individually, or two or more may be used in combination.

### Styrene-Based Resin

The styrene-based resin used in the binder resin is preferably a styrene-acrylic resin (styrene-acrylic acid ester copolymer resin). A monomer that can be used as a raw material for the resin preferably contains a styrene monomer as an essential monomer, and optionally contains a (meth)acrylic monomer and/or a carboxyl group-containing vinyl monomer. Here, the styrene-based resin means a homopolymer of a styrene monomer or a copolymer of a styrene monomer and another monomer. Here, the term “(meth)acrylic” means acrylic and/or methacrylic.

Examples of the styrene monomer include styrene, and alkylstyrenes having an alkyl group with from 1 to 3 carbon atoms (for example, α-methylstyrene and p-methylstyrene). Among these, styrene is suitable. One of these may be used individually, or two or more thereof may be used in combination.

Examples of the (meth)acrylic monomer include:
alkyl (meth)acrylates having an alkyl group with from 1 to 18 carbon atoms, such as methyl (meth)acrylate, ethyl (meth)acrylate, butyl (meth)acrylate, 2-ethylhexyl (meth)acrylate, lauryl (meth)acrylate, and stearyl (meth)acrylate;
hydroxylalkyl (meth)acrylates having an alkyl group with from 1 to 18 carbon atoms, such as hydroxyethyl (meth)acrylate;
alkylamino group-containing (meth)acrylates having an alkyl group with from 1 to 18 carbon atoms, such as dimethylaminoethyl (meth)acrylate and diethylaminoethyl (meth)acrylate; and
nitrile group-containing vinyl monomers such as acrylonitrile and methacrylonitrile.

Examples of the carboxyl group-containing vinyl monomer include monocarboxylic acids [with from 3 to 15 carbon atoms, for example, (meth)acrylic acid, crotonic acid, and cinnamic acid], dicarboxylic acids [with from 4 to 15 carbon atoms, for example, maleic acid (anhydride), fumaric acid, itaconic acid, and citraconic acid], and dicarboxylic acid monoesters [monoalkyl (with from 1 to 18 carbon atoms) esters of the dicarboxylic acids, for example, maleic acid monoalkyl esters, fumaric acid monoalkyl esters, itaconic acid monoalkyl esters, and citraconic acid monoalkyl esters].

Among these (meth)acrylic monomers and carboxyl group-containing vinyl monomers, alkyl (meth)acrylates with from 1 to 18 carbon atoms, acrylonitrile, methacrylonitrile, (meth)acrylic acid, dicarboxylic acid monoesters, and mixtures of two or more thereof are preferable.

### Polyester Resin

In the present embodiment, as the binder resin, a polyester resin is suitable among the above-described examples. It is known that polyester resins are hydrolyzed by heating, the lapse of time, or the like, and a dicarboxylic acid such as succinic acid produced as a hydrolysate act as the chelating agent. Therefore, in a case where the binder resin is a polyester resin, the dicarboxylic acid contained in a hydrolyzed toner (for example, a toner in a used two-component developer) functions as the elution aid.

The polyester resin used for the binder resin is usually produced by subjecting one or more selected from the group consisting of dihydric alcohol components and trihydric or higher polyhydric alcohol components and one or more selected from the group consisting of divalent carboxylic acids and trivalent or higher polyvalent carboxylic acids to a polycondensation reaction through an esterification reaction or a transesterification reaction by a known method.

The polyester resin is obtained by, for example, a polycondensation reaction between a carboxylic acid monomer including terephthalic acid, isophthalic acid, and succinic acid as main components and a polyhydric alcohol including ethylene glycol as a main component. In this case, a mole content rate of terephthalic acid, isophthalic acid, and succinic acid in the dicarboxylic acid monomer is preferably 70% or more and 100% or less, and more preferably 80% or more and 100% or less. Here, a mole content rate of ethylene glycol in the polyhydric alcohol is preferably 70% or more and 100% or less, and more preferably 80% or more and 100% or less.

The conditions in the condensation polymerization reaction are to be appropriately set according to the reactivity of the monomer components, and the reaction is to be terminated when the polymer has suitable physical properties. For example, the reaction temperature is approximately from 170 °C to 250 °C, and the reaction pressure is approximately from 5 mm Hg to normal pressure.

Examples of the dihydric alcohol component include alkylene oxide adducts of bisphenol A, such as poly(oxypropylene)(2.2)-2,2-bis(4-hydroxyphenyl)propane, poly(oxypropylene)(3.3)-2,2-bis(4-hydroxyphenyl)propane, poly(oxypropylene)(2.0)-2,2-bis(4-hydroxyphenyl)propane, poly(oxypropylene)(2.0)-poly(oxyethylene)(2.0)-2,2-bis(4-hydroxyphenyl)propane, and poly(oxypropylene)(6)-2,2-bis(4-hydroxyphenyl)propane; diols, such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenol A; propylene adducts of bisphenol A; ethylene adducts of bisphenol A; and hydrogenated bisphenol A.

Examples of the trihydric or higher polyhydric alcohol component include sorbitol, 1,2,3,6-hexanetetrol, 1,4-sorbitan, pentaerythritol, dipentaerythritol, tripentaerythritol, sucrose (cane sugar), 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

In the toner according to the present embodiment, one of the dihydric alcohol components and trihydric or higher polyhydric alcohol components may be used individually, or two or more in combination.

Examples of the divalent carboxylic acid include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, n-dodecenylsuccinic acid, n-dodecylsuccinic acid, n-octylsuccinic acid, isooctenylsuccinic acid, isooctylsuccinic acid, and acid anhydrides and lower alkyl esters of these.

Examples of the trivalent or higher polycarboxylic acid include 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl) methane, 1,2,7,8-octanetetracarboxylic acid, pyromellitic acid, Empol trimer acid, and acid anhydrides and lower alkyl esters of these.

In the toner according to the present embodiment, one of the divalent carboxylic acids and trivalent or higher polyvalent carboxylic acids may be used individually, or two or more in combination.

An acid value of the polyester resin is preferably 5 mgKOH/g or more and 30 mgKOH/g or less. When the acid value is less than the lower limit, charging characteristics of the resin may be deteriorated, or a charge control agent may be less likely to be dispersed in the polyester resin. This may adversely affect rise of a charge amount and stability of the charge amount when development is continuously and repeatedly performed. When the acid value exceeds the upper limit, hygroscopicity due to the functional group in the resin increases, and the charge amount may decrease in a high-temperature and high-humidity environment. The acid value is measured according to the potentiometric titration method described in Japanese Industrial Standard (JIS) K0070-1992.

A glass transition temperature (Tg) of the polyester resin can be appropriately selected depending on the purpose, but is preferably 40 °C or higher and 80 °C or lower in view of fixability and storage stability of the resulting toner. When the glass transition temperature of the polyester resin is lower than the lower limit, the storage stability is insufficient, and thus thermal aggregation of the toner in the image forming device is liable to occur, so that development failure may occur. In addition, the temperature at which a high-temperature offset phenomenon starts to occur is lowered. When the glass transition temperature of the polyester resin is higher than the upper limit, the fixability may be reduced, and fixing failure may occur.

A softening temperature (Tm) of the polyester resin can be appropriately selected depending on the purpose, but is preferably 150 °C or lower, and more preferably 60 °C or higher and 120 °C or lower. When the softening temperature of the polyester resin is lower than 60 °C, the storage stability of the toner is lowered, and the thermal aggregation of the toner in the image forming device is liable to occur, and thus the toner cannot be stably supplied to an image carrier, and development failure occurs. When the softening temperature of the polyester resin is higher than 120 °C, the toner is less likely to be melted or softened when the toner is fixed on a recording medium, and therefore, the fixability of the toner on the recording medium may be reduced, and fixing failure may occur.

A weight average molecular weight (Mw) of the polyester resin can be appropriately selected according to the purpose, but is preferably 5000 or more and 500000 or less. When the weight average molecular weight of the polyester resin is less than the lower limit, mechanical strength of the binder resin is reduced, and the obtained toner particles are easily pulverized by stirring or the like in the development device, and thus the shape of the toner particles is changed, and the charging performance may vary. When the weight average molecular weight of the polyester resin exceeds the upper limit, the polyester resin is less likely to be melted, and thus the fixability of the toner may be reduced, and fixing failure may occur. Here, the weight average molecular weight is a value in terms of polystyrene measured by gel permeation chromatography (GPC).

### Colorant

The toner particles according to the present embodiment contain a colorant. When the toner particles, which are resin particles, contain a colorant, resistance of the entire resin particles is lowered. Therefore, the charge generated when ions are eluted from the iron ion eluting body is likely to move through the toner. As the colorant in the toner particles in the present embodiment, organic and inorganic pigments and dyes of various types and colors commonly used in the field of electrophotography can be used, and examples thereof include black, white, yellow, orange, red, purple, blue, and green colorants.

Examples of a black colorant include carbon black, copper oxide, manganese dioxide, aniline black, activated carbon, nonmagnetic ferrite, magnetic ferrite, and magnetite.

Examples of the yellow colorant include chrome yellow, zinc yellow, cadmium yellow, yellow iron oxide, mineral fast yellow, nickel titanium yellow, navel yellow, naphthol yellow S, Hansa yellow G, Hansa yellow 10G, benzidine yellow G, benzidine yellow GR, quinoline yellow lake, Permanent Yellow NCG, tartrazine lake, C.I. Pigment Yellow 12, C.I. Pigment Yellow 13, C.I. Pigment Yellow 14, C.I. Pigment Yellow 15, C.I. Pigment Yellow 17, C.I. Pigment Yellow 93, C.I. Pigment Yellow 94, and C.I. Pigment Yellow 138.

Examples of the orange colorant include red chrome yellow, molybdenum orange, Permanent Orange GTR, pyrazolone orange, vulcan orange, Indanthrene Brilliant Orange RK, benzidine orange G, Indanthrene Brilliant Orange GK, C.I. Pigment Orange 31, and C.I. Pigment Orange 43.

Examples of the red colorant include red iron oxide, cadmium red, red lead, mercury sulfide, cadmium, Permanent Red 4R, Lithol Red, pyrazolone red, watching red, calcium salts, Lake Red C, Lake Red D, Brilliant Carmine 6B, eosin lake, Rhodamine Lake B, alizarin lake, Brilliant Carmine 3B, C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Examples of the violet colorant include manganese violet, fast violet B, and methyl violet lake.

Examples of the blue colorant include iron blue, cobalt blue, alkali blue lake, victoria blue lake, phthalocyanine blue, metal-free phthalocyanine blue, partially chlorinated phthalocyanine blue, Fast Sky Blue, Indanthrene Blue BC, C.I. Pigment Blue 15, C.I. Pigment Blue 15:2, C.I. Pigment Blue 15:3, C.I. Pigment Blue 16, and C.I. Pigment Blue 60.

Examples of the green colorant include chrome green, chromium oxide, Pigment Green B, mica light green lake, Final Yellow Green G, and C.I. Pigment Green 7.

Examples of the white colorant include zinc oxide, titanium oxide, antimony white, and zinc sulfide.

The colorant according to the present embodiment is preferably a conductive particle. When the colorant contained in the resin particles is a conductive particle, an effect of reducing the resistance of the entire resin particles is further enhanced.

The conductive particle may be made of any material as long as the particle has a property of conducting electricity, and examples thereof include carbon particles, metal particles, and particles coated with metal. In the present embodiment, a carbon particle is suitable. Examples of a carbon-based coloring material composed of carbon particles include carbon black, acetylene black, activated carbon, graphite, and porous carbon materials. One of these may be used individually, or two or more may be used in combination.

Among them, carbon black is suitable as the colorant from the viewpoint of cost and performance. The type of carbon black is not particularly limited, but from the viewpoint of handleability as the colorant, carbon black having a dibutyl phthalate (DBP) oil absorption amount in a range of 90 mL/100 g or more and 170 mL/100 g or less is suitably used. From the viewpoint of dispersibility and coloring properties, carbon black having an average primary particle size of 50 nm or less is particularly suitably used.

A content of the colorant in the toner particles according to the present embodiment is not particularly limited, but is preferably 3 mass % or more and 25 mass % or less, and more preferably 5 mass % or more and 20 mass % or less.

### Release Agent

The toner particles according to the present embodiment contain a release agent. As the release agent, any release agent commonly used in the field of electrophotography can be used. Examples include: petroleum-based waxes such as paraffin wax and derivatives thereof, and microcrystalline wax and derivatives thereof; hydrocarbon-based synthetic waxes such as Fischer-Tropsch wax and derivatives thereof, polyolefin wax and derivatives thereof, polypropylene wax and derivatives thereof, and polyolefin-based polymer wax (low molecular weight polyethylene wax and the like) and derivatives thereof; plant-based waxes such as carnauba wax and derivatives thereof, rice wax and derivatives thereof, candelilla wax and derivatives thereof, and wood wax; animal-based waxes such as beeswax and spermaceti wax; oil and/or fat-based synthetic waxes such as fatty acid amide, phenol fatty acid ester, and derivatives thereof; and silicone-based polymers and higher fatty acids. One of these may be used individually, or two or more may be used in combination. The derivatives include oxides; block copolymers of vinyl monomers and waxes, and graft-modified products of vinyl monomers and waxes.

A content of the release agent in the toner particles according to the present embodiment is, for example, 1 mass % or more and 10 mass % or less, and preferably 2 mass % or more and 5 mass % or less.

### Other Internal Additives

The toner particles according to the present embodiment may contain an internal additive other than the above. Examples of the internal additive other than the above include a charge control agent. The charge control agent is added to impart a preferable charging property to the toner. The charge control agent is not particularly limited, and charge control agents for positive charge control and negative charge control used in the field of electrophotography can be used.

The charge control agent according to the present embodiment preferably contains potassium. Accordingly, potassium ions can be eluted from the iron ion eluting body according to the present embodiment into the aqueous medium, nutrients are supplied to algae and phytoplankton, and water quality can be improved by photosynthesis thereof and the like.

Examples of the charge control agent for controlling negative charges include oil-soluble dyes such as oil black and spiro black, metal-containing azo compounds, azo complex dyes, metal complexes and metal salts of salicylic acid and derivatives thereof (metals such as chromium, zinc, and zirconium), boron compounds, fatty acid soaps, long-chain alkyl carboxylates, and resin acid soaps. Among these, boron compounds are preferred from the viewpoint of not containing heavy metals.

Examples of a charge control agent for positive charge control include quaternary ammonium salts, pyrimidine compounds, triphenylmethane derivatives, guanidine salts, and amidine salts.

One of these charge control agents may be used individually, or two or more thereof may be used in combination. The content of the charge control agent in the toner particle is preferably 0.5 mass % or more and 2 mass % or less.

### External Additive

In the toner according to the present embodiment, an external additive may adhere to the surfaces of the toner particles described above. As the external additive, those commonly used in the field of electrophotography can be used. The external additive according to the present embodiment preferably includes at least silica particles. A content of the silica particles is preferably 1 part by mass or more and 3 parts by mass or less relative to 100 parts by mass of the toner particles.

When the iron ion eluting body according to the present embodiment contains silica particles, harmful metal ions contained in the aqueous medium (for example, in water in a water area such as a river or a water channel) are adsorbed onto surfaces of the silica particles, and thus the water quality can be improved.

The mechanism of the adsorption of harmful metal ions is specifically thought to be as follows. When divalent iron ions are eluted from the iron ion eluting body according to the present embodiment into the aqueous medium, some of the iron ions are oxidized by dissolved oxygen in the aqueous medium and become trivalent. The trivalent iron ions become iron hydroxide and adsorb heavy metal ions. The iron hydroxide that has adsorbed heavy metals approaches the silica particles due to the zeta potential and is adsorbed onto the silica particles. The silica particles also adsorb harmful metals using the silanol groups (Si—OH) on the surfaces.

A median diameter of the silica particles is not particularly limited, but is preferably 200 nm or less, and more preferably 5 nm or more and 100 nm or less. When the median diameter of the silica particles is the upper limit or less, detachment of the silica particles from the iron ion eluting body according to the present embodiment can be suppressed. In addition, a specific surface area of the silica particles can be increased, and a larger amount of harmful metals can be adsorbed.

Examples of the silica particles as the external additive include silica particles commonly used in the field of electrophotography, for example, fumed silica particles obtained by burning silicon tetrachloride, dry-process silica particles such as arc process silica obtained by atomizing silica in a gas phase by high energy such as plasma, precipitated silica synthesized under an alkaline condition using a sodium silicate aqueous solution as a raw material, wet-process silica particles such as gel process silica synthesized under an acidic condition, colloidal silica particles obtained by making acidic silicic acid alkaline and polymerizing the acidic silicic acid, and sol-gel process silica particles obtained by hydrolyzing an organosilane compound.

Inorganic particles such as silica particles as the external additive may be inorganic particles to which hydrophobicity is imparted by surface treatment with a hydrophobizing agent such as a silane coupling agent, a titanium coupling agent, or silicone oil.

As the external additive other than silica particles, magnetite is sometimes added to a toner (particularly, a black toner having less restriction on color) in a dry developer for the purpose of improving handleability by magnetism and adjusting fluidity and chargeability.

In the iron ion eluting body according to the present embodiment, the toner preferably contains magnetite as the external additive. This allows fine iron-containing particles to be present in a state of being dispersed on the surfaces of the toner particles, and thus the iron ions are eluted more rapidly in the aqueous medium.

The magnetite as the external additive may have a saturation magnetization of 55 Am²/kg or more and 84 Am²/kg or less, and a coercive force of 8 kA/m or more and 12 kA/m or less.

An average particle size of the magnetite as the external additive is preferably 0.05 μm or more and 1 μm or less, and more preferably 0.1 μm or more and 0.5 μm or less. When the average particle size is within the above range, the magnetite is held on the surfaces of the toner particles with an appropriate strength.

A content of the magnetite in the iron ion eluting body according to the present embodiment is preferably 0.05 parts by mass or more and 5 parts by mass or less, more preferably 0.1 parts by mass or more and 4 parts by mass or less, and still more preferably 0.5 parts by mass or more and 3 parts by mass or less with respect to 100 parts by mass of the toner particles.

### EXAMPLES

Hereinafter, the iron ion eluting body of the disclosure will be specifically described on the basis of Examples and Comparative Examples.

### 1. Measurement Method

### Method for Measuring Median Diameter of Carrier

The median diameters of a carrier and a carrier core material are measured using Microtrac (available from Nikkiso Co., Ltd., product name: MT3000). About from 10 mg to 15 mg of a sample (carrier or carrier core material) is added to 10 mL of a 5% aqueous solution of EMULGEN 109P (product name, polyoxyethylene lauryl ether HLB 13.6, available from Kao Corporation) and dispersed for 1 minute with an ultrasonic disperser. About 1 mL of this is added to a predetermined portion of the Microtrac and then stirred for 1 minute to confirm that the scattered light intensity is stabilized, and then measurement is performed.

### Method for Measuring Median Diameter of Toner Particle

To 50 mL of an electrolytic solution (available from Beckman Coulter, K.K., product name: ISOTON-II), 20 mg of toner particles and 1 mL of a sodium alkyl ether sulfate are added. The mixture is subjected to dispersion treatment at a frequency of 20 kHz for 3 minutes using an ultrasonic disperser (available from As One Corporation, product: Desktop Dual Frequency Ultrasonic Cleaner VS-D100) to obtain a measurement sample. On the obtained measurement sample, measurement is performed using a particle size distribution measuring device (available from Beckman Coulter, K.K., product name: Multisizer 3) under conditions of an aperture size of 100 μm and the number of measurement particles of 50000 counts, and the median diameter is determined from the volumetric particle size distribution.

### Method for Measuring Toner Concentration in Two-Component Developer

The toner concentration in the two-component developer is confirmed using a particle charge amount measuring device (available from TREK Corporation, model: 210HS-2A). Specifically, first, about 0.2 g of a two-component developer is placed on a table, and covered with a stainless steel mesh (795 mesh). Next, a suction nozzle is applied onto the mesh to suck the toner in the two-component developer. Thereafter, the weight of the developer remaining on the table is measured to determine the toner concentration.

### 2. Production of Raw Material

### Production of Carrier A

Carbon black (available from Lion Specialty Chemicals Co., Ltd., product name: Ketjen Black EC) was added at an amount of 5.0 mass % to a silicone resin (available from Shin-Etsu Chemical Co., Ltd., product name: KR-255) serving as a coating resin, and the mixture was dispersed in toluene to obtain a dispersion. The obtained dispersion was applied onto a carrier core material (median diameter: 60 μm) of iron powder using a fluidized bed type coating device, the applied coating resin was cured by heating at 250 °C for 2 hours, and a carrier A was thereby obtained.

### Production of Carrier B

A carrier B was obtained in the same manner as in the “Production of Carrier A” except that a carrier core material of Mn—Mg-based ferrite (median diameter: 50 μm) was used instead of the carrier core material of iron powder.

Preparation of Extracted Residue (Preparation of Coffee Residue and Tea Residue) Pulverized commercially available coffee beans were sealed in an extraction pack and extracted with hot water at a temperature of 80 °C for 3 minutes. Next, the coffee beans after extraction were taken out from the extraction pack and exposed to air to be dried until the moisture content reached 5% or less, and then pulverized by a pulverizing mill to prepare a dry powder (that is, coffee residue). As for tea residue, a dry powder was prepared in the same manner except that commercially available tea leaves were used instead of the commercially available coffee beans.

### 3. Production of Toner, Two-Component Developer, and Iron Ion Eluting Body Example 1

Toner particles (toner core) were produced using the following toner raw materials.
Binder resin: 91 mass % of a polyester resin
Colorant: 6 mass % of carbon black (available from Mitsubishi Chemical Corporation, product name: MA-77, arithmetic average particle size: 23 nm)
Release agent: 2 mass % of Fischer-Tropsch wax (melting point: 90 °C, available from Nippon Seiro Co., Ltd., product name: FNP-0090)
Charge control agent: 1 mass % of potassium salt (compound name: potassium bis [benzilato (2-)-κ(2)O,O]borate (1-), solubility in water at 20 °C: 4.382 g/L, available from Nippon Carlit Co., Ltd., product name: Ion Conductive Material LR-147)

### Mixing and Melt-Kneading Step

The above-described toner raw materials were premixed for 5 minutes at a rotational speed of 1500 rpm using a high-performance fluid-type mixer (Henschel mixer, total capacity: 20 L, available from Mitsui Mining Co., Ltd. (now Nippon Coke & Engineering Co., Ltd.), model: FM20C).

The obtained mixture was melt-kneaded using a twin-screw extruder (model: PCM-30, available from Ikegai Corp.) under conditions including a cylinder temperature setting of 100 °C, a barrel rotational speed of 250 rpm, and a raw material feeding rate of 10 kg/hour. The melt-kneaded product was collected, cooled and solidified with a cooling belt, and then coarsely pulverized to obtain kneaded product flakes.

### Fine Pulverization and Classification Step

After addition of 3 parts by mass of citric acid (available from Hayashi Pure Chemical Ind., Ltd., product name: Citric Acid (Anhydrous)) as the first additive to 100 parts by mass of the kneaded product flakes, the mixture was finely pulverized using a fluidized bed type opposed jet mill (available from Hosokawa Micron Corporation, model: Counter Jet Mill AFG), and classified (particle size-adjusted) using a rotary classifier (available from Hosokawa Micron Corporation, model: TSP Separator) to obtain toner particles having a particle size in a range of from 5.0 μm to 7.0 μm.

### External Addition Step

To 100 parts by mass of the obtained toner particles, 1 part by mass of silica particles (available from Nippon Aerosil Co., Ltd., product name: R976s) as the external additive was added, and the mixture was mixed at a rotation speed of 3500 rpm for 3 minutes using a high-performance fluid-type mixer (Henschel mixer, total capacity: 20 L, available from Mitsui Mining Co., Ltd., model: FM20C) to obtain a toner.

### Developer Production Step

The toner obtained in the “External Addition Step” and the carrier A obtained in the “Production of Carrier A” were weighed so as to attain a toner concentration of 7.0% (mass of toner/mass of carrier=1/13.3), and mixed with a V-type mixer (available from TOKUJU CORPORATION, model: V-5) for 20 minutes to obtain a two-component developer.

### Iron Ion Eluting Body Production Step

The obtained two-component developer was placed in a wide-mouthed bottle (available from AS ONE Corporation, product name: I-Boy PP Wide Mouth Bottle 50 mL) and mixed using a double-shaft driven plastic bottle rotating table (available from Tanaka Tech Co., Ltd., model: RPB-3S). The two-component developer after the mixing was pressed using a desktop press machine (available from NPA System Co., Ltd., product name: 50 kN Table Press TB-50H) under conditions of @ 25 cemented carbide die, 30 MPa, and 1 minute to form a cylindrical pellet having a diameter of 25 mm.

### Examples 2 to 9, 12, and 20 to 28 and Comparative Examples 1 to 2

Table 1 below shows a list of the first additives used in Examples, and summarizes information on components that function as elution aids contained in the additives, and the like. In the disclosure, the term “water-soluble” means that 1 g or more of a target substance is dissolved in 100 g of water at 20 °C. In the column of water solubility in Table 1, the case where the target substance is water-soluble so that 1 g or more of the target substance is dissolved in 100 g of water at 20 °C is indicated as “◯”, the case where the target substance is poorly soluble so that 0.1 g or more and less than 1 g of the target substance is dissolved therein is indicated as “Δ”, and the case where the target substance is water-insoluble so that only less than 0.1 g of the target substance is dissolved is indicated as “x”. In addition, although the solubility of an ionic compound increases, the water-solubility is determined based on the solubility of the component alone. Although it is difficult to clearly determine the water solubility of catechins and chlorogenic acids because they contain decomposition products and the like, it is estimated that the water solubility is approximately from “◯” to “Δ”.

TABLE 1

| | | | | Water |
|---|---|---|---|---|
| | Product name of | Component | Classifi- | solubility |
| | additive and | as elution | cation as | of component |
| Additive | preparation | aid in | elution | as elution |
| species | method | additive | aid | aid |
| Citric acid | Citric Acid | Anhydrous | Chelating | ∘ |
| | (Anhydrous), | citric acid | agent | |
| | available from | | | |
| | Hayashi Pure | | | |
| | Chemical Ind., | | | |
| | Ltd. | | | |
| Na | L-glutamic acid- | Glutamic | Chelating | Δ |
| glutamate | sodium | acid | agent | |
| | (monohydrate), | | | |
| | available from | | | |
| | Kishida Chemical | | | |
| | Co., Ltd. | | | |
| Iron | Fe (III)-EDTA, | EDTA | Chelating | x |
| EDTA | available from | | agent | |
| | Dojindo | | | |
| | Laboratories | | | |
| Iron | Dissolvine D-Fe- | DTPA | Chelating | x |
| DTPA | 11, available | | agent | |
| | from Nouryon | | | |
| Ascorbic | L (+)-ascorbic | L-ascorbic | Reducing | ∘ |
| acid | acid (for research | acid | organic | |
| | and experiment), | | substance | |
| | available from | | | |
| | Hayashi Pure | | | |
| | Chemical Ind., | | | |
| | Ltd. | | | |
| Tea | Prepared | Catechin | Reducing | From ∘ to Δ |
| residue | according to | | organic | |
| | “Preparation of | | substance | |
| | Extracted | | | |
| | Residue” | | | |
| Coffee | Prepared | Chlorogenic | Reducing | From ∘ to Δ |
| residue | according to | acids | organic | |
| | “Preparation of | | substance | |
| | Extracted | | | |
| | Residue” | | | |

In Examples 2 to 9, 12, and 20 to 28, an iron ion eluting body was obtained in the same manner as in Example 1 except that the type of the carrier, the toner concentration, and the type and the addition amount of the first additive were changed as shown in Tables 2 to 5 below.

### Example 10

An iron ion eluting body was obtained in the same manner as in Example 2 except that, in the external addition step, 2 parts by mass of carbon black (available from Mitsubishi Chemical Corporation, product name: MA-77) was further added to 100 parts by mass of the obtained toner particles, in addition to 1 part by mass of the silica particles as the external additive.

### Example 11

An iron ion eluting body was obtained in the same manner as in Example 2 except that, in the external addition step, 2 parts by mass of magnetite was further added to 100 parts by mass of the obtained toner particles, in addition to 1 part by mass of the silica particles as the external additive.

### Example 13

An iron ion eluting body was obtained in the same manner as in Example 2, except that, in the developer production step, 3 parts by mass of 100 parts by mass of the weighed toner was replaced with iron EDTA (available from Dojindo Laboratories, product name: Fe (III)-EDTA) as the first additive instead of adding citric acid to the kneaded product flakes before the fine pulverization step, and then that a two-component developer was obtained.

### Example 14

An iron ion eluting body was obtained in the same manner as in Example 2, except that, in the developer production step, 3 parts by mass of 100 parts by mass of the weighed toner was replaced with iron DTPA (available from Nouryon, product name: Dissolvine D-Fe-11) as the first additive instead of adding citric acid to the kneaded product flakes before the fine pulverization step, and then that a two-component developer was obtained.

### Example 15

First, the used two-component developer in which the binder resin of the toner was a polyester resin and the colorant was carbon black was collected from several image forming devices to prepare approximately 1 kg of the used two-component developer. The toner concentration in the two-component developer was confirmed to be about 5.6%. Next, the two-component developer was placed under heated water vapor at 300 °C for 30 minutes to promote hydrolysis of the polyester resin contained in the toner in the developer. Thus, a two-component developer containing a dicarboxylic acid (for example, succinic acid) as a toner decomposition product was obtained. An iron ion eluting body was produced in the same manner as in Example 2 except that this two-component developer was used and that no elution aid was separately added.

### Example 16

The used two-component developer to be prepared was changed from the developer in which the colorant was carbon black (denoted as “Bk_CB” in Table 2) in Example 15 to a developer in which the colorant was C.I. Pigment Blue 15:3 (denoted as “Cy” in Table 2). The toner concentration in the two-component developer was confirmed to be about 6.1%. Except for this, an iron ion eluting body was produced in the same manner as in Example 15.

### Example 17

An iron ion eluting body was produced in the same manner as in Example 2 except that the binder resin was changed from the polyester resin (denoted as “PES” in Table 2) to a styrene-acrylic resin (denoted as “StAc” in Table 2, available from Mitsubishi Rayon Co., Ltd.).

### Example 18

An iron ion eluting body was produced in the same manner as in Example 2 except that the colorant was changed from carbon black to C.I. Pigment Blue 15:3.

### Example 19

An iron ion eluting body was produced in the same manner as in Example 7 except that the toner concentration was changed from 7.5% to 25%.

### Example 29

An iron ion eluting body was produced in the same manner as in Example 16 except that the binder resin was changed from the polyester resin to a styrene-acrylic resin (available from Mitsubishi Rayon Co., Ltd.).

### Example 30

An iron ion eluting body was produced in the same manner as in Example 26 except that the toner concentration was changed from 7.5% to 25%.

### Comparative Example 3

In the developer production step, 3 parts by mass of 100 parts by mass of the weighed toner was replaced with citric acid (available from Hayashi Pure Chemical Ind., Ltd., product name: Citric Acid (Anhydrous)) as the first additive instead of adding citric acid to the kneaded product flakes before the fine pulverization step, and then a two-component developer was obtained. This two-component developer was used, as an iron ion eluting body, in the form of powder without being molded into a cylindrical pellet.

TABLE 2

| | | | | | Developer | | | Toner | | |
|---|---|---|---|---|---|---|---|---|---|---|
| | | | | | | Content | Content | | | Content |
| | | Carrier | | | | [wt. %] of | [wt. %] of | | | [wt. %] of |
| | Shape of | | | Particle | Toner | elution | carbon | Type | Type | colorant |
| | eluting | | D50 | size: (D90 − | concentration | aid in | material in | of | of | in toner |
| | body | Material | [μm] | D10)/D50 | [wt. %] | developer | developer | resin | colorant | particle |
| Example | Molded | Iron | 60 | 1.3 | 5 | 0.15% | 0.30% | PES | Bk_CB | 6 |
| 1 | body | powder | | | | | | | | |
| Example | Molded | Ferrite | 50 | 1.1 | 7.5 | 0.22% | 0.45% | PES | Bk_CB | 6 |
| 2 | body | | | | | | | | | |
| Example | Molded | Ferrite | 50 | 1.1 | 7.5 | 0.01% | 0.45% | PES | Bk_CB | 6 |
| 3 | body | | | | | | | | | |
| Example | Molded | Ferrite | 50 | 1.1 | 7.5 | 0.02% | 0.45% | PES | Bk_CB | 6 |
| 4 | body | | | | | | | | | |
| Example | Molded | Ferrite | 50 | 1.1 | 7.5 | 0.07% | 0.45% | PES | Bk_CB | 6 |
| 5 | body | | | | | | | | | |
| Example | Molded | Ferrite | 50 | 1.1 | 7.5 | 0.74% | 0.45% | PES | Bk_CB | 6 |
| 6 | body | | | | | | | | | |
| Example | Molded | Ferrite | 50 | 1.1 | 7.5 | 2.23% | 0.45% | PES | Bk_CB | 6 |
| 7 | body | | | | | | | | | |
| Example | Molded | Ferrite | 50 | 1.1 | 3 | 0.09% | 0.18% | PES | Bk_CB | 6 |
| 8 | body | | | | | | | | | |
| Example | Molded | Ferrite | 50 | 1.1 | 20 | 0.59% | 1.19% | PES | Bk_CB | 6 |
| 9 | body | | | | | | | | | |
| Example | Molded | Ferrite | 50 | 1.1 | 7.5 | 0.22% | 0.44% | PES | Bk_CB | 6 |
| 10 | body | | | | | | | | | |
| Example | Molded | Ferrite | 50 | 1.1 | 7.5 | 0.22% | 0.44% | PES | Bk_CB | 6 |
| 11 | body | | | | | | | | | |
| Example | Molded | Ferrite | 50 | 1.1 | 7.5 | 0.22% | 0.45% | PES | Bk_CB | 6 |
| 12 | body | | | | | | | | | |
| Example | Molded | Ferrite | 50 | 1.1 | 7.5 | 0.22% | 0.45% | PES | Bk_CB | 6 |
| 13 | body | | | | | | | | | |
| Example | Molded | Ferrite | 0 | 1.1 | 7.5 | 0.22% | 0.45% | PES | Bk_CB | 6 |
| 14 | body | | | | | | | | | |
| Example | Molded | Ferrite | 50 | 1.1 | 5.6 | (Decomposition | 0.36% | PES | Bk_CB | 6 |
| 15 | body | | | | | product) | | | | |
| Example | Molded | Ferrite | 50 | 1.1 | 6.1 | (Decomposition | 0.00% | PES | Cy | 6 |
| 16 | body | | | | | product) | | | | |
| Example | Molded | Ferrite | 50 | 1.1 | 7.5 | 0.22% | 0.45% | StAc | Bk_CB | 6 |
| 17 | body | | | | | | | | | |
| Example | Molded | Ferrite | 50 | 1.1 | 7.5 | 0.22% | 0.00% | PES | Cy | 6 |
| 18 | body | | | | | | | | | |
| Example | Molded | Ferrite | 50 | 1.1 | 25 | 7.43% | 1.49% | PES | Bk_CB | 6 |
| 19 | body | | | | | | | | | |

TABLE 3

| | First additive (toner decomposition product in Examples 15 and 16) | | | | | Second additive | | |
|---|---|---|---|---|---|---|---|---|
| | | | | | Added | | | Added |
| | | | | | number | | | number |
| | Additive | Component as | Classification | Addition | of parts | Additive | Addition | of parts |
| | species | elution aid | as elution aid | timing | [parts] | species | timing | [parts] |
| Example 1 | Citric acid | Anhydrous | Chelating | Before fine | 3 | — | — | — |
| | | citric acid | agent | pulverization step | | | | |
| Example 2 | Citric acid | Anhydrous | Chelating | Before fine | 3 | — | — | — |
| | | citric acid | agent | pulverization step | | | | |
| Example 3 | Citric acid | Anhydrous | Chelating | Before fine | 0.1 | — | — | — |
| | | citric acid | agent | pulverization step | | | | |
| Example 4 | Citric acid | Anhydrous | Chelating | Before fine | 0.3 | — | — | — |
| | | citric acid | agent | pulverization step | | | | |
| Example 5 | Citric acid. | Anhydrous | Chelating | Before fine | 1 | — | — | — |
| | | citric acid | agent | pulverization step | | | | |
| Example 6 | Citric acid | Anhydrous | Chelating | Before fine | 10 | — | — | — |
| | | citric acid | agent | pulverization step | | | | |
| Example 7 | Citric acid | Anhydrous | Chelating | Before fine | 30 | — | — | — |
| | | citric acid | agent | pulverization step | | | | |
| Example 8 | Citric acid | Anhydrous | Chelating | Before fine | 3 | — | — | — |
| | | citric acid | agent | pulverization step | | | | |
| Example 9 | Citric acid | Anhydrous | Chelating | Before fine | 3 | — | — | — |
| | | citric acid | agent | pulverization step | | | | |
| Example | Citric acid | Anhydrous | Chelating | Before fine | 3 | Carbon | Before | 2 |
| 10 | | citric acid | agent | pulverization step | | black | external | |
| | | | | | | | addition | |
| | | | | | | | step | |
| Example | Citric acid | Anhydrous | Chelating | Before fine | 3 | Magnetite | Before | 2 |
| 11 | | citric acid | agent | pulverization step | | | external | |
| | | | | | | | addition | |
| | | | | | | | step | |
| Example | Na glutamate | Glutamic acid | Chelating | Before fine | 3 | — | — | — |
| 12 | | | agent | pulverization step | | | | |
| Example | Iron EDTA | EDTA | Chelating | Before developer | 3 | — | — | — |
| 13 | | | agent | production step | | | | |
| Example | Iron DTPA | DTPA | Chelating | Before developer | 3 | — | — | — |
| 14 | | | agent | production step | | | | |
| Example | (Toner | Dicarboxylic | Chelating | (Not added | — | — | — | — |
| 15 | decomposition | acid (succinic | agent | because of | | | | |
| | product) | acid or the | | decomposition | | | | |
| | | like) | | product) | | | | |
| Example | (Toner | Dicarboxylic | Chelating | (Not added | — | — | — | — |
| 16 | decomposition | acid (succinic | agent | because of | | | | |
| | product) | acid or the | | decomposition | | | | |
| | | like) | | product) | | | | |
| Example | Citric acid | Anhydrous | Chelating | Before fine | 3 | — | — | — |
| 17 | | citric acid | agent | pulverization step | | | | |
| Example | Citric acid | Anhydrous | Chelating | Before fine | 3 | — | — | — |
| 18 | | citric acid | agent | pulverization step | | | | |
| Example | Citric acid | Anhydrous | Chelating | Before fine | 30 | — | — | — |
| 19 | | citric acid | agent | pulverization step | | | | |

TABLE 4

| | | | | | Developer | | | Toner | | |
|---|---|---|---|---|---|---|---|---|---|---|
| | | Carrier | | | | Content | Content | | | Content |
| | | | | Particle | | [wt. %] of | [wt. %] of | | | [wt. %] of |
| | Shape of | | | size: | Toner | elution | carbon | | | colorant |
| | eluting | | D50 | (D90 − | cocentration | aid in | material | Type of | Type of | in toner |
| | body | Material | [μm] | D10)/D50 | [wt. %] | developer | developer | resin | colorant | particle |
| Example 20 | Molded | Ferrite | 50 | 1.1 | 7.5 | 0.22% | 0.45% | PES | Bk_CB | 6 |
| | body | | | | | | | | | |
| Example 21 | Molded | Ferrite | 50 | 1.1 | 7.5 | 0.00% | 0.45% | PES | Bk_CB | 6 |
| | body | | | | | | | | | |
| Example 22 | Molded | Ferrite | 50 | 1.1 | 7.5 | 0.01% | 0.45% | PES | Bk_CB | 6 |
| | body | | | | | | | | | |
| Example 23 | Molded | Ferrite | 50 | 1.1 | 7.5 | 0.02% | 0.45% | PES | Bk_CB | 6 |
| | body | | | | | | | | | |
| Example 24 | Molded | Ferrite | 50 | 1.1 | 7.5 | 0.07% | 0.45% | PES | Bk_CB | 6 |
| | body | | | | | | | | | |
| Example 25 | Molded | Ferrite | 50 | 1.1 | 7.5 | 0.74% | 0.45% | PES | Bk_CB | 6 |
| | body | | | | | | | | | |
| Example 26 | Molded | Ferrite | 50 | 1.1 | 7.5 | 2.23% | 0.45% | PES | Bk_CB | 6 |
| | body | | | | | | | | | |
| Example 27 | Molded | Ferrite | 50 | 1.1 | 7.5 | 0.22% | 0.45% | PES | Bk_CB | 6 |
| | body | | | | | | | | | |
| Example 28 | Molded | Ferrite | 50 | 1.1 | 7.5 | 0.22% | 0.45% | PES | Bk_CB | 6 |
| | body | | | | | | | | | |
| Example 29 | Molded | Ferrite | 50 | 1.1 | 7.5 | 0.22% | 0.45% | StAc | Bk_CB | 6 |
| | body | | | | | | | | | |
| Example 30 | Molded | Ferrite | 50 | 1.1 | 25 | 7.43% | 1.49% | PES | Bk_CB | 6 |
| | body | | | | | | | | | |
| Comparative | Molded | Iron | 60 | 1.3 | 5 | 0.00% | 0.30% | PES | Bk_CB | 6 |
| Example 1 | body | powder | | | | | | | | |
| Comparative | Molded | Ferrite | 50 | 1.1 | 7.5 | 0.00% | 0.45% | PES | Bk_CB | 6 |
| Example 2 | body | | | | | | | | | |
| Comparative | Powder | Ferrite | 50 | 1.1 | 7.5 | 0.22% | 0.45% | PES | Bk_CB | 6 |
| Example 3 | | | | | | | | | | |

TABLE 5

| | First additive | | | | |
|---|---|---|---|---|---|
| | | | | | Added |
| | | | | | number |
| | | Component | Classifi- | | of |
| | Additive | as elution | cation as | Addition | parts |
| | species | aid | elution aid | timing | [parts] |
| Example | Ascorbic | L-ascorbic | Reducing | Before fine | 3 |
| 20 | acid | acid | organic | pulverization | |
| | | | substance | step | |
| Example | Ascorbic | L-ascorbic | Reducing | Before fine | 0.03 |
| 21 | acid | acid | organic | pulverization | |
| | | | substance | step | |
| Example | Ascorbic | L-ascorbic | Reducing | Before fine | 0.1 |
| 22 | acid | acid | organic | pulverization | |
| | | | substance | step | |
| Example | Ascorbic | L-ascorbic | Reducing | Before fine | 0.3 |
| 23 | acid | acid | organic | pulverization | |
| | | | substance | step | |
| Example | Ascorbic | L-ascorbic | Reducing | Before fine | 1 |
| 24 | acid | acid | organic | pulverization | |
| | | | substance | step | |
| Example | Ascorbic | L-ascorbic | Reducing | Before fine | 10 |
| 25 | acid | acid | organic | pulverization | |
| | | | substance | step | |
| Example | Ascorbic | L-ascorbic | Reducing | Before fine | 30 |
| 26 | acid | acid | organic | pulverization | |
| | | | substance | step | |
| Example | Tea | Catechin | Reducing | Before fine | 3 |
| 27 | residue | acids | organic | pulverization | |
| | | | substance | step | |
| Example | Coffee | Chlorogenic | Reducing | Before fine | 3 |
| 28 | residue | acids | organic | pulverization | |
| | | | substance | step | |
| Example | Ascorbic | L-ascorbic | Reducing | Before fine | 3 |
| 29 | acid | acid | organic | pulverization | |
| | | | substance | step | |
| Example | Ascorbic | L-ascorbic | Reducing | Before fine | 30 |
| 30 | acid | acid | organic | pulverization | |
| | | | substance | step | |
| Compar- | Not added | — | — | — | 0 |
| ative | | | | | |
| Example 1 | | | | | |
| Compar- | Not added | — | — | — | 0 |
| ative | | | | | |
| Example 2 | | | | | |
| Compar- | Citric | — | — | Before | 3 |
| ative | acid | | | developer | |
| Example 3 | | | | production | |
| | | | | step | |

### 4. Evaluation

### Measurement and Evaluation of Amount of Iron Ion Eluted

The iron ion eluting body produced in each of Examples and Comparative Examples was introduced into distilled water, and the amount of iron ions eluted into the distilled water after a predetermined time had elapsed was measured by the following procedure.

Measurement with Initial Distilled Water

Specifically, first, the produced iron ion eluting body and distilled water in an amount 20 times the mass of the iron ion eluting body (for example, 100 g of distilled water when the amount of the iron ion eluting body is 5 g) were put into a glass sample bottle, and the sample bottle was left to stand in an indoor environment. After 8 hours, 3 days, and 10 days of standing, the iron ion concentration of the supernatant of the distilled water in the sample bottle was measured using a semi-quantitative ion test paper (available from MACHEREY-NAGEL, product name: QUANTOFIX). The iron ion concentration is determined by a colorimetric sample, and thus has a value having a range.

Measurement with Distilled Water after Replacement

Next, suction filtration was performed with a membrane filter having a pore size of 1 μm to collect an iron ion eluting body. The collected iron ion eluting body and distilled water in an amount 20 times the mass of the iron ion eluting body were placed in a glass sample bottle. The distilled water was replaced in this manner, and the sample bottle was left to stand in an indoor environment. After 1 day and 10 days of standing, the iron ion concentration of the supernatant of the distilled water in the sample bottle was measured in the same manner as in the “Measurement with Initial Distilled Water”.

### Evaluation Criteria

The amount of iron ions eluted was evaluated based on the iron ion concentrations measured in the “Measurement with Initial Distilled Water” and the “Measurement with Distilled Water after Replacement” according to the following criteria.
⊚ (Excellent): Iron ion concentration is 50 mg/L or more.
◯ (Good): Iron ion concentration is 10 mg/L or more and less than 50 mg/L.
Δ (Acceptable): Iron ion concentration is 2 mg/L or more and less than 10 mg/L.
x (Unacceptable): Iron ion concentration is less than 2 mg/L.

TABLE 6

| | Evaluation with initial | | | Evaluation with distilled | |
|---|---|---|---|---|---|
| | distilled water | | | water after replacement | |
| | | After | After | 1 day after | 10 days after |
| | 8 h | 3 days | 10 days | replacement | replacement |
| Example 1 | ⊚ | ⊚ | ⊚ | ◯ | ⊚ |
| Example 2 | ◯ | ◯ | ⊚ | ◯ | ◯ |
| Example 3 | Δ | Δ | ◯ | Δ | Δ |
| Example 4 | Δ | ◯ | ⊚ | Δ | ◯ |
| Example 5 | ◯ | ◯ | ⊚ | Δ | ◯ |
| Example 6 | ◯ | ⊚ | ⊚ | ◯ | ◯ |
| Example 7 | ◯ | ⊚ | ⊚ | ◯ | ◯ |
| Example 8 | ◯ | ⊚ | ⊚ | ◯ | ◯ |
| Example 9 | ◯ | ⊚ | ⊚ | ◯ | ⊚ |
| Example 10 | ⊚ | ⊚ | ⊚ | ◯ | ⊚ |
| Example 11 | ⊚ | ⊚ | ⊚ | ⊚ | ⊚ |
| Example 12 | ◯ | ◯ | ⊚ | ◯ | ◯ |
| Example 13 | ◯ | ◯ | ⊚ | Δ | ◯ |
| Example 14 | ◯ | ◯ | ⊚ | Δ | ◯ |
| Example 15 | Δ | Δ | ◯ | Δ | Δ |
| Example 16 | Δ | Δ | Δ | Δ | Δ |
| Example 17 | ◯ | ◯ | ⊚ | ◯ | ◯ |
| Example 18 | ◯ | ◯ | ◯ | ◯ | ◯ |
| Example 19 | ⊚ | ⊚ | ⊚ | ◯ | ⊚ |

TABLE 7

| | Evaluation with initial | | | Evaluation with distilled | |
|---|---|---|---|---|---|
| | distilled water | | | water after replacement | |
| | | After | After | 1 day after | 10 days after |
| | 8 h | 3 days | 10 days | replacement | replacement |
| Example 20 | ⊚ | ⊚ | ⊚ | ◯ | ◯ |
| Example 21 | Δ | ◯ | ⊚ | Δ | ◯ |
| Example 22 | ◯ | ⊚ | ⊚ | ◯ | ◯ |
| Example 23 | ⊚ | ⊚ | ⊚ | ◯ | ◯ |
| Example 24 | ⊚ | ⊚ | ⊚ | ◯ | ◯ |
| Example 25 | ⊚ | ⊚ | ⊚ | ⊚ | ⊚ |
| Example 26 | ⊚ | ⊚ | ⊚ | ⊚ | ⊚ |
| Example 27 | Δ | ◯ | ◯ | Δ | ◯ |
| Example 28 | Δ | ◯ | ◯ | Δ | ◯ |
| Example 29 | ⊚ | ⊚ | ⊚ | ◯ | ◯ |
| Example 30 | ⊚ | ⊚ | ⊚ | ⊚ | ⊚ |
| Comparative | X | X | Δ | X | Δ |
| Example 1 | | | | | |
| Comparative | X | X | X | X | X |
| Example 2 | | | | | |
| Comparative | ◯ | ⊚ | ⊚ | X | X |
| Example 3 | | | | | |

Tables 6 and 7 show evaluation results of the amounts of iron ions eluted in Examples and Comparative Examples. According to Tables 6 and 7, the iron ion eluting bodies of Examples 1 to 30, which are molded bodies obtained by press-molding iron-containing compositions containing the following (A) to (C), provided rapid elution of iron ions in an aqueous medium, and continued the elution of iron ions even after the aqueous medium was replaced with a new one. In these Examples, (A) is derived from the carrier, and (B) is derived from the toner.
(A) A magnetic particle containing iron.
(B) A resin particle containing a colorant.
(C) An elution aid that reacts with iron or a compound containing iron to form an iron complex.

On the other hand, Comparative Examples 1 to 3 in which these requirements were not satisfied were evaluated as “x” for at least one of the evaluation results of the amount of iron ions eluted, and were inferior to Examples. Comparative Examples 1 and 2 are examples in which the first additive containing a component as the elution aid is not added. Comparative Example 3 is an example in which the iron ion eluting body is not a molded body obtained by press-molding, but a powder.

According to Examples 1 to 19, it is understood that a chelating agent can be used as the elution aid. In addition, according to Examples 20 to 30, it is understood that a reducing organic substance can be used as the elution aid.

In Comparative Example 1, which does not contain the elution aid, it takes time to elute iron ions, and the amount of the iron ions eluted is small. In contrast, in Examples 1 to 30, a sufficient amount of iron ions were eluted from the initial stage of the introduction into distilled water, and it is understood that the ion eluting bodies of these Examples are excellent in fast-acting property.

In addition, in Comparative Example 3 in which the iron ion eluting body is a powder, the elution of iron ions occurs from the initial stage, but the elution performance is lost after the distilled water is replaced, and thus it is considered that the elution aid is lost from the iron ion eluting body at an early stage. In contrast, in Examples 1 to 30, the elution of iron ions is continued even after the distilled water is replaced, and it is understood that the iron ion eluting bodies of these Examples are also excellent in durability of the effect.

In Example 1, the carrier in the iron ion eluting body contains metal iron, whereas in Example 2, the carrier in the iron ion eluting body contains ferrite that is more oxidized than metal iron. According to Example 2, it is understood that even when ferrite is contained as the iron component, the elution of iron ions occurs. In Comparative Example 2 in which the carrier core material is ferrite as in Example 2, the elution of iron ions was not detected, and therefore, the elution of iron ions in Example 2 is considered to be an effect of citric acid as the chelating agent.

Among the chelating agents used as the elution aids in Examples, anhydrous citric acid is water-soluble, whereas glutamic acid, EDTA (ethylenediaminetetraacetic acid), and DTPA (diethylenetriaminepentaacetic acid) are water-insoluble. It is understood that Example 1 and the like in which the elution aid is water-soluble are superior to Examples 12, 13, and 14 in which the elution aid is water-insoluble in the evaluation after 8 hours and 3 days in the “Evaluation with initial distilled water” and the evaluation after 1 day in the “Evaluation with distilled water after replacement”. That is, it is understood that the fast-acting property is excellent.

Example 10 is different from Example 2 in that carbon black as the carbon material is added before the external addition step, that is, carbon black is further added separately from carbon black as the colorant contained in the toner particles. It is understood that Example 10 in which the carbon material is added as described above is superior to Example 2 in various evaluations of the amount of iron ions eluted.

Example 11 is different from Example 2 in that magnetite is added before the external addition step, that is, the toner used contains magnetite as the external additive. It is understood that Example 11 in which the toner contains magnetite as the external additive is superior to Example 2 in various evaluations of the amount of iron ions eluted.

In Example 15, the hydrolysis of the polyester resin contained in the toner was promoted by placing the used two-component developer under heated water vapor, and the obtained iron ion eluting body contains a dicarboxylic acid (for example, succinic acid) as a toner decomposition product. It is known that polyester resins are hydrolyzed by heating, the lapse of time, or the like, and a dicarboxylic acid as a hydrolysate act as the chelating agent. For example, succinic acid is water-soluble so that 5.8 g thereof is dissolved in 100 g of water at 20 °C. According to Example 15, it is understood that the dicarboxylic acid as the toner decomposition product functions as the elution aid by using the polyester resin as the binder resin of the toner.

In Example 15, the colorant contained in the toner is carbon black, whereas in Example 16, the colorant contained in the toner is C.I. Pigment Blue 15:3. According to Example 16, it is understood that even the iron ion eluting body produced using the used two-component developer containing the color toner provides rapid elution of iron ions in an aqueous medium, and continues the elution of iron ions even after the aqueous medium is replaced with a new one. Further, according to the comparison between Example 15 and Example 16, it is found that Example 15 in which carbon black as a conductive particle was used as the colorant is superior in the evaluation after 10 days in the “Evaluation with initial distilled water”, and that the elution of iron ions is more continued.

Examples 2 to 7 and Examples 20 to 26 are examples in which the amounts of the chelating agent and the reducing organic substance added as the elution aid were changed. According to these Examples, it is found that when the content of the elution aid in the iron ion eluting body is 0.1 parts by mass or more and 30 parts by mass or less with respect to 100 parts by mass of the toner, iron ions are rapidly eluted into the distilled water, and that the elution of iron ions is continued even after the distilled water is replaced with new one. Also, according to these Examples, it is found that the content of the elution aid in the iron ion eluting body is preferably 0.5 parts by mass or more, and more preferably 2 parts by mass or more with respect to 100 parts by mass of the toner.

Examples 8 and 9 are examples in which the toner density was changed from that in Example 2. In these Examples, it is considered that since the elution aid was added in the fine pulverization step in the toner production, the amount of the elution aid remaining on the toner side increased as the toner concentration increased, and that the elution performance of iron ions was maintained high even after the distilled water was replaced with new one. In this Example, the toner concentration in the iron ion eluting body is preferably 6% or more, and more preferably 10% or more.

Examples 27 and 28 are examples in which used coffee residue or tea residue was used as the first additive instead of pure chemical substances. Although it is considered that the active ingredient is reduced because the residue is obtained after extraction with hot water, it is understood from both Examples that the effect is exhibited even when such processed products of plant bodies are used as the additive.

According to Examples 17 and 29, it is found that even when the binder resin of the toner is a styrene-acrylic resin, an iron ion eluting body in which iron ions are rapidly eluted in an aqueous medium and the elution of iron ions is continued even after the aqueous medium is replaced with a new one can be realized. According to Examples 15 and 16, it is understood that, since the binder resin of the toner is a polyester resin, the dicarboxylic acid as the toner decomposition product functions as the elution aid, and thus that the binder resin is more preferably a polyester resin.

Example 18 is different from Example 2 in that the colorant contained in the toner is not carbon black, but C.I. Pigment Blue 15:3. It is understood that Example 2 in which carbon black as a conductive particle is contained as the colorant is superior to Example 18 in the evaluation after 10 days in the “Evaluation with initial distilled water”, and that the elution of iron ions is more continued.

Examples 19 and 30 are different from Examples 7 and 26, respectively, in that the toner concentration in the two-component developer was changed from 7.5% to 25%. For example, according to the comparison between Example 7 and Example 19, it is found that Example 19 having a high toner concentration is more excellent in the evaluation after 8 hours in the “Evaluation with initial distilled water” and the evaluation after 10 days in the “Evaluation with distilled water after replacement”, and is more excellent in the fast-acting property and durability of the elution of iron ions. From this viewpoint, the toner concentration in the two-component developer (that is, the mass ratio of the resin particles to the iron ion eluting body) is preferably 7% or more, more preferably 10% or more, and even more preferably 20% or more.

The embodiment disclosed herein is illustrative in all respects and is not the basis for a limited interpretation. Accordingly, the technical scope of the disclosure is not to be construed by the foregoing embodiment only, and is defined based on the description of the claims. In addition, meanings equivalent to the range of the claims and all changes made within the range are included.

### REFERENCE SIGNS LIST

10 Iron ion eluting body
11 Toner composite
12 Toner (resin particle)
13 Elution aid
14 Carrier (magnetic particle)

1. An iron ion eluting body that elutes iron ions in an aqueous medium, the iron ion eluting body being a molded body obtained by press-molding an iron-containing composition, the iron-containing composition comprising:
a magnetic particle containing iron;
a resin particle containing a colorant; and
an elution aid that reacts with iron or a compound containing iron to form an iron complex.

2. The iron ion eluting body according to claim 1,
wherein the elution aid is at least one of a chelating agent and a reducing organic substance.

3. The iron ion eluting body according to claim 1,
wherein the elution aid is water-soluble.

4. The iron ion eluting body according to claim 1,
wherein the iron-containing composition further comprises a carbon material.

5. The iron ion eluting body according to claim 4,
wherein the carbon material is carbon black.

6. The iron ion eluting body according to claim 1,
wherein magnetite is attached to a surface of the resin particle.

7. The iron ion eluting body according to claim 1,
wherein the colorant is a conductive particle.

8. The iron ion eluting body according to claim 1,
wherein a resin constituting the resin particle is a polyester resin.

9. A method of producing an iron ion eluting body that elutes iron ions in an aqueous medium, the method comprising:
an addition step of adding an elution aid that reacts with iron or a compound containing iron to form an iron complex to a two-component developer composed of a toner and a carrier to obtain an iron-containing composition; and
a molding step of press-molding the iron-containing composition to obtain a molded body.

10. A method of producing an iron ion eluting body that elutes iron ions in an aqueous medium, the method comprising:
a heating step of heating a two-component developer composed of a toner containing a polyester resin and a carrier; and
a molding step of press-molding the two-component developer after the heating step to obtain a molded body.
